(19) United States
(12) Patent Application Publication
(10) Pub. No.: US 2007/0146367 A1
(43) Pub. Date: Jun. 28, 2007

(54) System for editing and conversion of distributed simulation data for visualization

(75) Inventor: Edward P. Harvey JR., Virginia Beach, VA (US)

Correspondence Address: STAAS & HALSEY LLP, SUITE 700, 1201 NEW YORK AVENUE, N.W., WASHINGTON, DC, 20005, US

(73) Assignee: Alion Science and Technology Corporation, McLean, VA (US)

(21) Appl. No.: 11/598,701

(22) Filed: Nov. 14, 2006

Related U.S. Application Data
(60) Provisional application No. 60/736,344, filed on Nov. 14, 2005.

(51) Int. Cl. G06T 15/70

(52) U.S. Cl. 345/473

(57) ABSTRACT

A simulation system for generating movie “scenes” that show interactions between simulated entities that populate a synthetic environment used to support training exercises and equipment. The simulation system includes a simulation engine that produces simulated entity state and event data; a visualization suite that allows an editor to display 2-D and 3-D views of the synthetic battlespace and to hear the battlefield and communications sounds associated with an interaction; a digital data logger that records simulation entity state and event data; an editing processor that provides the functionality required to identify, filter, specify, and organize the “scenes” that make up an interaction of interest; a “scene” generator that converts the entity state and event data for the set of scenes that make up an interaction into a digital movie file; and a repository for storage of complete movies and copying of movies to removable media.

### CROSS-REFERENCE TO RELATED APPLICATION(S)

This application is related to and claims priority to U.S. Provisional Patent Application entitled SYSTEM FOR EDITING AND CONVERSION OF DISTRIBUTED SIMULATION DATA FOR VISUALIZATION having Ser. No. 60/736,344, by Edward R. Harvey, Jr, filed Nov. 14, 2005 and incorporated by reference herein.

### BACKGROUND

The present invention relates to an editor and scene generator for use in the visualization of simulation data.

Modeling may be considered to be the application of a standard or structured methodology to create and/or validate a physical, mathematical, or other logical representation of a system, entity, or phenomenon. A simulation is simply a method for implementing a behavior or model over time. Thus, simulation may be used to determine empirically probabilities by means of experimentation. Computer systems can create and host visualizations of synthetic environments with a high level of realism, special effects, and model detail that enable visualization of or immersion into the environment being simulated. Aside from the traditional applications of modeling and simulation, synthetic environments are increasingly being used for entertainment, gaming, training, testing, equipment evaluation, or other experimentation.

Within the simulation field, technology improvements have increasingly enabled the creation of larger and more realistic computer-generated synthetic environments (simulations) including high-fidelity representations of real-world systems, objects, and environments. Capabilities to analyze and reason about the simulation information and its results, however, are lagging due to ineffective or unavailable methods for organizing and presenting the enormous volume of possible simulation outputs. This technology limitation is especially the case for training and analysis environments where it may be desirable to use a single, large-scale, geographical dispersed synthetic environment to provide meaningful outputs for multiple persons, organizations, and objectives. Depending on the intended use, simulation outputs may need to be presented from various different viewpoints by using multiple media formats. Frequently, the most intuitive method to present simulation outputs is through the use of visualization and animation. As needed, it is also useful to augment the visual presentation of data with aural, haptic, text, and other non-visual information. Combining the multiple types of simulation data and results into a single cohesive animated and interactive movie provides a meaningful and enhanced training and analysis capability. Current tools do not provide an efficient method to rapidly and iteratively process and manage the simulation outputs into a usable movie output.

Simulations may be categorized into live, virtual, and constructive simulation elements. These categories overlap, in that many simulations are hybrids or combinations of categories. A virtual simulation involves a human inserted into a central role of a simulated system, while a hybrid virtual and constructive simulation might involve a human that operates a constructive model of actual equipment, such as an aircraft simulation. A purely constructive simulation may involve human input, but that input would not determine the outcome. A visualization of a synthetic environment is essentially the formation of an image composed of data streams produced by these various elements, including those that are not normally visible. Historically, data would be presented as text or numbers, or graphically displayed as an image. The image could be animated to display time varying data. However, the complexities of synthetic environments, and simulation modeling in particular, compound the difficulties in achieving effective visualization using disparate or diverse data.

Current technologies for visualization of simulations range from the complex to the simple. Complex visualizations involve substantial computer processing and may include immersive, virtual worlds wherein individuals (i.e., live elements) interact with virtual elements in a simulation model via an interface. A simple visualization may be conversion of a status or outcome into some graphical display over a period of time. As mentioned above, visualization of simulations may include data from live (e.g., humans with real equipment on instrumented training ranges), virtual (e.g., humans in vehicle simulators), and constructive (e.g., synthetic humans operating simulated equipment) elements. Historical approaches to debriefing would simply take the output of a simulation generator, with synchronized data and screen capture capability, to produce an audio-visual work. From the perspective of an operator, this is insufficient for audio-visual works, animations, or movies that are intended for debriefing or after action review and analysis of the simulation/training exercises.

Some current technologies time-stamp data within one or more data streams to enable synchronization of the data for playback during a debriefing. This approach involves collecting or recording data, marking or associating the data media with a time indicator, and coordinating or synchronizing the data from the various data streams for debriefing. A debriefing may involve play of all or a selected time portion of the simulation. For example, in a flight simulator, common data streams may include video of the pilot, audio of pilot and crew communications, event state, and instrumentation output. The data collected may be digitized, synchronized, and displayed for purposes of training or debriefing. Data steams of interest are typically identified in advance or manually selected subsequent to the simulation. This arrangement may be appropriate for a time step simulation with a limited number of data sources because the states or status of some or all resources are updated as of each point in time.

In many simulations, however, much of the data to be collected may be irrelevant to the training purpose of interest or the sheer quantity of information may prevent the rapid preparation of an effective visualization. For example, a simulation may involve many events with some probability of occurrence. Data collection may be required for all such events regardless of how unlikely the occurrence may be; unlikely events may provide valuable information for training, should the event occur. As environments, such as a battle space (synthetic or real) or immersive environment, becomes more complicated and realistic, the quantity of data and information becomes difficult to manage. Such complicated simulation environments often involve different perspectives of single events, multiplying data sets. Further, in some simulations, there may be no explicit relationship between external time and the rate of advancement within the simulation, leading to inconsistent timing for events or occurrences with high training value. For example, some simulations are “as-fast-as-possible” or unconstrained simulations. Such an unconstrained simulation may be an element of a larger federated or distributed simulation that is constrained. Alternatively, there may be a constrained simulation as a component of a larger unconstrained simulation or federation of simulations. This discontinuity in constraints further complicates the association of data for subsequent visualization.

In order to produce an audio video file (e.g., movie or animation) of a simulation that can be used for training, such as an “after action review,” (AAR) and to debrief trainees, the following capabilities and features are useful or required:

(a) the ability to filter the relevant simulation state and event data for the interaction or events of interest from the massive amount of state and event data generated over the duration of a distributed simulation exercise;

(b) the ability to abstract details from the simulation state and event data as desired for an audio video file for AAR;

(c) the ability to visualize the interaction in two and three dimensions from multiple perspectives or viewpoints;

(d) the ability to incorporate sounds or other aural signals into a movie or animation from the appropriate points in the simulation event or interaction (e.g., battlefield sounds or voice communications);

(e) the ability to rapidly select, edit, and organize the two and three dimensional perspectives or views and to associate the proper sounds at the proper points to produce a draft animation or movie “script” for review; and

(f) the ability to convert interaction simulation state and event data into a movie file format that can be stored on a hard disk drive and transferred to removable storage media such as a CD-ROM.

There is currently no system having the above capabilities; that is, there is no system for generating animation or movie scenes that display the complex interactions between simulated entities that populate a synthetic environment. It is contemplated that a system meeting these objectives could be used to support a variety of training and entertainment needs, such as military training exercises, experiments, education, etc.

### SUMMARY

It is an aspect of the embodiments discussed herein to provide a simulation system with an editor process for the reduction of simulation data, the selection of data scenes from the reduced simulation data and the generation of movie script data from the selected scenes. The movie script data of the editor process is further used by a scene generator to create a sequence of auto-visual scenes which are then formatted into know audio-visual file formats.

In a simulation method, state data is obtained, the state data relating to at least one physical parameter of a system as the physical parameter changes over time. For example, the state data may relate to a continuum of data points over time for at least one of position, orientation, appearance, temperature and pressure. The state data is put into chronological sequence and then filtered to include data points associated with a selected entity within the system. Further, the state data is filtered to include data points associated with entities that interact with the selected entity. The state data is also filtered to include only data points that occur during a particular event experienced by the system. A video viewpoint is selected from which to view the system. Video is generated for the state data after filtering the state data, the video being generated from the video viewpoint.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a representative prior art simulation system;

FIG. 2 is a diagram of the components according to one possible embodiment of the present invention;

FIG. 3 is a process diagram of a Editor Processor; and

FIG. 4 is a process diagram of a Scene Generator.

### DETAILED DESCRIPTION OF THE PREFERRED EMBODIMENTS

The inventors propose an editor and scene generation processor to produce animations, scenes, or movie files from the data generated by Simulation Engines. Simulation Engines may be considered as software and hardware elements that generate entity state and event data. In implementation, Simulation Engines are highly complex and usually tailored to specific experiments; for the purposes herein, Simulation Engines are treated in the abstract, without particular detail as the system may be adapted to a variety of such engines and applications. The system may also be adapted to use with multiple Simulation Engines in a federation of multiple simulations.

As noted above, the early mechanism for interacting with a simulation was primarily through a basic graphic user interface (GUI); output entity or event data were provided in tabular or simple graphical formats. As simulation became more widely employed in training, animation or visualization software was developed to display the Simulation Engine output as synchronized data. Thus, the output of a simulation generator was visualized and screen capture capability could be used to produce an audio-visual work. The visualization software provided the capability to display predetermined parameters regarding the progress and conclusion of the modeling experiment. The introduction of time stamping of data has improved visualization technologies; however, these technologies are typically limited to focused simulations with limited data streams and predetermined parameters of interest.

Most visualization software is tailored to a corresponding field of simulation, such as medical, manufacturing, military, or environmental models. Accordingly, the parameters of interest are generally determined by the subject matter of the models desired for those fields. For example, visualization software for an environmental simulation of a leaking fuel tank model may display the migration of fuel through soil and ground water. This example might show animated parameters communicating solute and particle contamination or concentration over time by reference to some predetermined coordinate system. Such visualization software is unsuitable for the complex relationships between independent simulation events that have not previously been defined or determined.

The complexities of simulations for synthetic environments, and simulation modeling in particular, produce disparate or diverse data; frequently, much data is of unpredictable value until an event or entity state change has occurred. The system is an Editor and Scene Generator capable of re-constructing Simulation Engine output data into a meaningful visual and aural environment for review, debrief, etc. This capability requires in-depth knowledge of the data specifications, their significance, and their time and space relationships. The increasing quality and complexity of Simulation Engines provide an increasingly broad base of event and state data, which permits the assembling of complex scenarios over time. Thus, animation or “movie scripts” may be derived from this data. The Editor Processor permits the selection of data soon after its generation. Importantly, the Editor Processor permits the selection of data from a plurality of parameters or simulation elements that may be recognized to be of interest only following a simulated event or state change. The animations produced by the Editor Processor and Scene Generator are therefore useful for education, training, or entertainment.

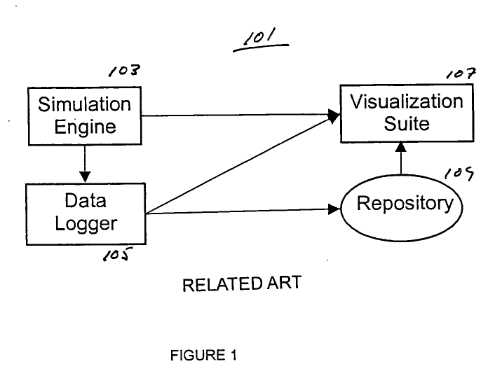

FIG. 1 is the system architecture of a typical simulation 101 including the following hardware and software components: Simulation Engine 103 to produce simulated entity state and event data; digital Data Logger 105 that records simulation entity state and event data; Visualization Suite 107 that displays two and three dimensional views of a synthetic environment and to produce the sounds associated with a simulated interaction; and storage device or Repository 109 for storage of output data and completed animations. These components are depicted in the abstract, and may be arranged in a variety of ways, depending on the application.

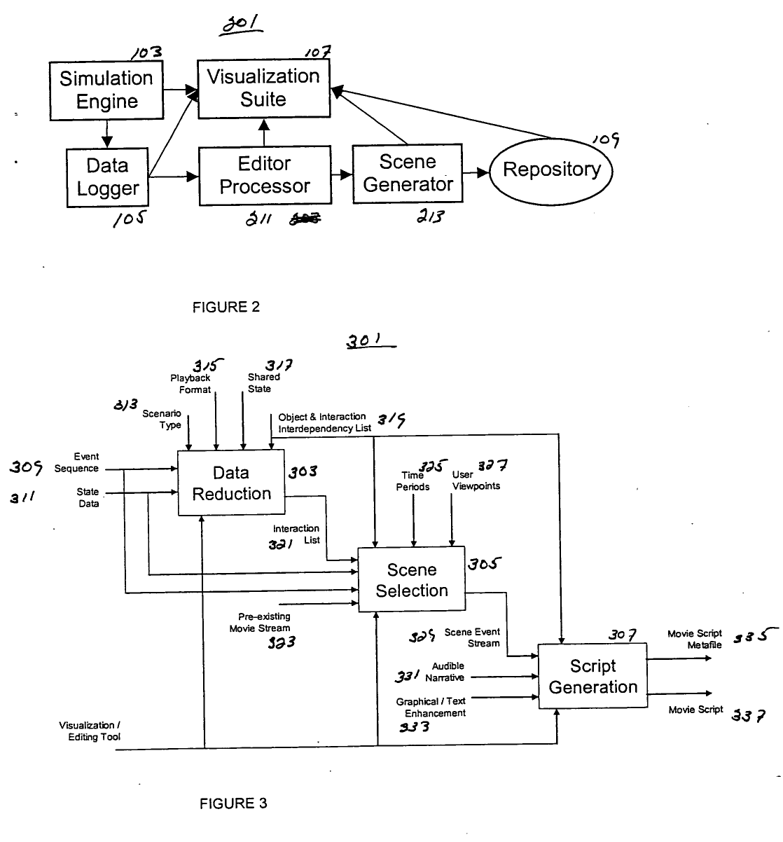

With reference to FIG. 2, a modified system architecture 102 has the following hardware and software components: Simulation Engine 103 to produce the simulated entity state and event data; digital Data Logger 105 that records simulation entity state and event data; Editor Processor 211 to identify, filter, specify, and organize the “scenes” that make up an interaction of interest; Visualization Suite 107 that allows an editor to display two and three dimensional views of a synthetic environment and to produce the sounds associated with a simulated interaction; Scene Generator 213 that converts the entity state and event data for the set of scenes that make up an interaction into a digital animation or audio-video file; and storage device or Repository 109 for storage of complete animations or movies, as well as the transfer or copying of movies to removable media, such as a CD-ROM. The following graphic is a high level depiction of the system architecture. Although these components are described in the singular, in many applications one or more of the individual components may be included; for example, as discussed above, a federation simulation may involve a plurality of Simulation Engines 103.

Many of the above components, excepting Editor Processor 211 and the Scene Generator 213, are relatively known to those in the field. These may be supplied from commonly available products or commercial off-the-shelf (COTS) items. Various Simulation Engines 103, Visualization Suites 107, Data Loggers 105, and repository hardware/software components 109 may be used and integrated, depending on their individual compatibility and the intended application.

Editor Processor 211 and Scene Generator 213 will be described in greater detail below. By way of introduction, Editor Processor 211 and Scene Generator 213, along with the modified architecture, introduce the capability of producing an audio-video file, such as an animation or movie, based on the complex interactions in the simulation entity state and event data. For example, a simulation within a synthetic battle space may be run to completion. Editor Processor 211 may then be used to select and organize scenes from an infinite number of possibilities of two and three dimensional perspectives or views derived from entity state and event data. Editor Processor 211 provides the functionality to review data, and produce and organize the scenes. In a domain-specific example, a simulated unit of several aircraft (i.e., perhaps with each aircraft an identified entity), controlled by both an airborne and ground-based air controllers (i.e., entities); the unit executes a mission that concludes with a weapon firing event, a weapon detonation event, and a series of detonation effects (e.g. missile strike, damage, smoke, and assessment). During the course of the mission, several other events or interactions occur between simulated entities, such as voice communication and sensor input and output. This mission may occur as an element in the context of a larger simulated battle. The proposed system, including Editor Processor 211 and Scene Generator 213, would be capable of rapidly re-constructing selected events in a sequence and style dictated by the editor. The resulting product could then be shared and displayed using currently available audio-video display technology.

Any Simulation Engine 103 capable of producing entity state data (e.g., position, orientation, velocity, acceleration, vehicle markings, etc.) and event data (e.g., emission, weapon launch, detonation, collision, etc.) may be used. Entity state and event data may be in a variety of formats, such as Distributed Interactive Simulation (DIS), High Level Architecture (HLA), or Test and Training and Enabling Architecture (TENA), network protocol format, or a custom network protocol format. Simulation Engine 103 may be used to plan and execute a scenario or experiment that can range from a simple set of interactions between two entities (e.g., such an “entity” may be any one object, such as a manufacturing device, a subsystem, a vehicle or aircraft, a biological organism, a ship, an individual human, etc.) to a large scale simulation including tens of thousands of entities that populate a synthetic environment, such as a battle space. The synthetic environment or battle space may be a simulated terrain, ocean, atmosphere, or space within which the simulated entities interact to accomplish assigned modeled tasks, functions, missions, or goals. Editor Processor 211 and Scene Generator 213 may use the entity state and event data output from any Simulation Engine 103, so long as that output is in a known digital format, such as DIS, HLA, TENA, or a custom network protocol.

Data Logger 105 may be any commercially available logging device having the necessary and typical recording and playback functions. In general, a data logger is simply a device that records measurements over time. In this case, Data Logger 105 is a digital device that records entity state and event data produced by Simulation Engine 103. Data Logger 105 may also be used to transmit the recorded data for post-exercise viewing for analysis, debriefing, and after action review purposes using Visualization Suite 107. Data Logger 105 may be configured to transmit selected portions of a recorded exercise or to transmit the recorded data faster or slower than real time.

Visualization Suite 107 includes two-dimensional (2-D) and three dimensional (3-D) viewing software applications. These viewing applications may be configured for use with appropriate graphical user interfaces (GUIs) and hardware. A variety of 2-D and 3-D viewing applications may be used to visualize the output of Simulation Engine 103 in real-time or following the completion of a simulation session. 2-D viewing applications typically depict entity state (e.g., location and orientation) and events (e.g., interactions or occurrences, such as detonations), on some form of situational display, such as a map-like tactical display. 3-D viewers show entity state and events from selected perspectives or viewpoints in an animated-like display. Visualization Suite 107 may associate audio signals along with the video of a 3-D display. Post simulation viewings may be used to review recorded entity state and event data, or for after action review and debrief purposes. Visualization Suite 107 may be “driven” by entity state and event data generated by Simulation Engine 103 in real time, or by recorded entity state and event data transmitted by Data Logger 105. Visualization Suite 107 may be used simultaneously to view the output of Simulation Engine 103 in real time and the output of a previously recorded exercise transmitted by Data Logger 105 for comparison purposes; however, this would be an unusual way for an instructor, analyst, or editor to use Visualization Suite 107.

Repository may be any commercially available digital data storage device (e.g. computer hard drive) with sufficient capacity for storage of multiple audio-video files, and preferably includes the capability to transfer such files to removable storage media such as a CD-ROM.

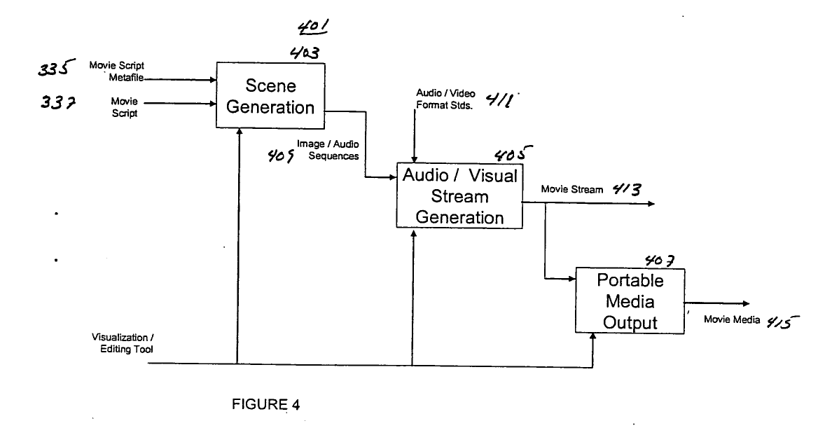

Editor Processor 211 and Scene Generator 213 expand the functionality of the above components and are depicted as component process diagrams in FIG. 3 and FIG. 4. These two diagrams are simplified variants of Integrated Definition Methods (IDEF0) for functional modeling and show the functional component process as a set of boxes. Component inputs enter the boxes from the left and component outputs exit the box on the right. Constraints or determinants enter the top of the box and resources the component process requires enter the bottom of the box.

Editor Processor 211 is depicted in FIG. 3 and has three sub-components necessary to generate movie scripts 335-337 required by the scene generator: 1) Data Reduction 303, 2) Scene Selection 305, and 3) Script Generation 307. Data Reduction component 303 provides a way for an operator (or “editor”) to selectively filter the large volumes of modeling and simulation data from potentially multiple sources. This filter is the first order data reduction to isolate a set of interactions 321 that may serve as the basis of an audio-video animation or movie. In this context, an interaction may be a sequence of state changes 311 and events 309 by one or more entities interacting in the synthetic environment. The interaction may be identified before or after the simulation. For example, the above described aircraft strike may involve a set of interactions that could be specified for filtering. When defining filters for the data reduction function, an operator will need to understand the constraints of filtering to include scenario type 313 (can't filter on an object that is not part of the event sequence or shared data), the type of input format event sequence 315 and shared data 317 are entering the system as (e.g., HLA, DIS), and the types of shared state data that are not a defined part of event sequence 309 network packet sequence. The outputs of the data reduction component are Interaction List 321 (viewed as a stream or set) of inter-related interactions and/or events. Data reduction component 303 is able to determine what interactions are inter-related by Object and Interaction Interdependency List 319 that operates as a constraint on the data reduction component. Data Reduction 303 functions are implemented as a software sub-component specific to Editor Processor 211. The following pseudo-code provides a high-level description of the computer processing performed within the Data Reduction 315 software used to establish the filters:

Create and manage Operator Interface Thread
Read Scenario Type and Format Specifications File
Read Object/Interaction Causal Specifications File
Read Shared State Specifications File
Set Data Reduction default parameters
For Graphical User Interface (GUI) inputs
   Select desired scenario type and playback format
   Select desired objects and interactions for visualization/analysis
   Perform causal chain analysis on object/interaction list
   Generate object/interaction interdependency list
   Extract allowable shared state data from object/interaction interdependency list
   Select script generation start/restart

Create and manage Interaction List Thread
While there are more events in the Event Sequence input data stream
   Synchronize by time the event sequence and state data streams
   If the current event and state data is in the object/interaction interdependency list
      Add data to Interaction List

Once Editor Processor 315 has been used to reduce the data stream to desired set of interactions 321 and object interdependencies 319, an operator/editor will review the interaction set and select: a) time period of interest 325, and b) specific view of the data 327. View 327 may be from a visual perspective, as seen in the visualization tool, or it may be from a logical perspective (e.g., trace history of intelligence information for a specific mission). Editor Processor 211 provides multiple methods of displaying and presenting the intended data to the screen and incorporating that in an eventual audio-visual stream (i.e., movie or animation). The primary objective of Scene Selection 305 component is to identify the set of scenes that present the actions of the entities or events of interest in a 2-dimensional or 3-dimensional format to include the use of audio and text. Additionally, Editor Processor 211 is able to specify the scene rate, specifically for real-time, faster-than-real-time, and slower-than-real-time data presentation. Scene Selection 305 component is capable of reading in pre-existing audio-visual stream 323 for modification. Scene Selection 305 functions are implemented as a software sub-component specific to Editor Processor 211. The following pseudo-code provides a high-level description of the computer processing performed within Scene Selection 305 software used to create the visual review environment and the scene event stream used by the script generation functions:

Create and manage Operator Interface Thread
Read Object/Interaction Interdependency List
For Graphical User Interface (GUI) inputs
   Select scenario event sequence and state data streams OR existing movie file
   Select user viewpoints
   Select scenes navigation options and time periods

Create and manage Visualization Thread
Initialize user viewpoints
While there are more events in the Event Sequence input data stream
   Stream relevant events to user viewpoints
   Process user viewpoint data
   Display/visualize user viewpoint

The next component within Editor Processor 211 is used to generate the actual movie script 337 that defines all of the events, objects, and interactions that will be used to create audio-visual stream 413 in scene generator 213. At this stage in the process, Editor Processor 211 is used to add additional text 333, narrative 331, or other audio overlays to existing stream of scenes (interactions) 329. The outputs of this Script Generation 307 is a script-based specification that defines the movie scenes, time segments, subscripts, notes, icons, and other information overlays required for generating the actual audio-visual stream. There is also meta-file 335 associated with script file 327 that is used to describe information about the contents of the file. This is useful for managing the information about all the script files maintained in the system repository.

Further, Editor Processor 211 has the capability to store more than one set of specifications related to scene event stream 329, thereby providing a method to customize and optimize the visualization and information presentation. This capability enhances the system training, education, and entertainment value by allowing for the selection of the desired perspectives of the desired interactions. During a debriefing, one or more parties may thereby view the same event from different perspectives or the system can allow different events to be viewed from the same perspective. In addition, this feature enables a rapid comparison and production of relevant audio-video files; for example, an editor may evaluate the data, generate the specification for interactions of interest, and within a short time after completion of a simulation, train or debrief personnel using the visualization most effective for those personnel.

The combined output from Editor Processing 211 provides the necessary data stream (335-337) to Scene Generator component 213. Scene Generator 213 is a graphics rendering engine capable of producing animation output in a standard audio-video (i.e., motion picture) format. When commanded by an editor, Scene Generator 213 automatically converts interaction scene data specifications and generates the appropriate audio-visual file of the scene visualization/animation generated by Editor Processor component 211. Additionally, Scene Generator 213 provides functions to format and install the movie stream(s) onto different types of distribution media 415 (e.g., CD, DVD). The resulting audio-video file may also be input back into Editor Processor 211 for viewing and used as a basis for re-generating a new event interaction stream using the Visualization tool 107 and Editor Processor 211. FIG. 4 depicts the three sub-components of Scene Generator 213: 1) Scene Generation 403, 2) Audio-Visual Stream Generation 405, and 3) Portable Media Output 407. Scene Generation sub-component 403 converts the movie script 337 files from Editor Processor 211 into a series of properly sequenced images 409. These images 409 are then used as inputs into Audio-Visual Stream Generation 405 along with Audio/Video Format Standards 411 to create the output files 413 in industry standard movie file formats (e.g., avi). If desired, the movie stream can be redirected to Scenario Generation sub-component (Portable Media Output) 407 that re-produces the movie onto portable medium 415.

In conclusion, the Editor Processor 211 and Scene Generator 213 are used within modified simulation system architecture. Editor Processor 211 introduces the capability to produce an audio-video file, such as an animation or movie, based on the complex interactions in the simulation entity state and event data. This component enables an editor to select, filter, and review Simulation Generator 201 data from one or more simulations; further, this component permits the selection or filtering of data generated within a single simulation. When coupled with a Scene Generator 213, Editor Processor 211 is capable of producing audio-video files such as animation or movies derived from the entity and state data.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A simulation system, the simulation system comprising:
an editor process, the editor process producing movie script files from simulation data of objects in a simulation, the movie script files generated by filtering the simulation data further refined by time, viewpoint, and/or relationship to other objects in the simulation; and
a scene generator, the scene generator producing from movie scripts files animation of the simulation in a given movie format.

2. A simulation method comprising:
obtaining state data relating to at least one physical parameter of a system as the physical parameter changes over time;
filtering the state data to include data points associated with a selected entity within the system;
filtering the state data to include data points associated with entities that interact with the selected entity;
filtering the state data to include only data points that occur during a particular event experienced by the system;
selecting a video viewpoint from which to view the system; and
generating video for the state data after filtering the state data, the video being generated from the video viewpoint.

3. The simulation method according to claim 2, further comprising chronologically sequencing the state data.

4. The simulation method according to claim 2 wherein the state data relates to a continuum of data points over time for at least one of position, orientation, appearance, temperature and pressure.
